(19) United States
(12) Patent Application Publication
(10) Pub. No.: US 2026/0337725 A1
(43) Pub. Date: Oct. 29, 2026

(54) METHOD AND SYSTEM FOR THE PROCESSING OF RARE EARTH CONCENTRATE

(71) Applicant: Ree Uno SpA, Santiago (CL)

(72) Inventors: Ricardo SEPULVEDA LETELIER, Concepcion (CL); Nicole Alejandra SAN MARTIN LEIVA, Concepcion (CL)

(21) Appl. No.: 19/119,557

(22) PCT Filed: Jun. 7, 2023
(86) PCT No.: PCT/IB2023/055888

§ 371 Date: Apr. 9, 2025

(30) Foreign Application Priority Data
Oct. 13, 2022 (CL) 2827-2022

(51) Int. Cl. C22B 59/00; C22B 3/02; C22B 3/42; C22B 3/44

(52) U.S. Cl. CPC C22B 59/00; C22B 3/02; C22B 3/42; C22B 3/44

(57) ABSTRACT

The invention relates to a method and a system for the processing of rare earth concentrate, which allow efficiency to be improved in terms of recovering the mineral and the resources involved in the process. The method comprises the steps of: a) reception and conditioning of the raw material; b) sorting of the material flow of interest; c) extraction of lanthanides; d) precipitation of impurities; e) precipitation of rare earth concentrate; and f) drying of the rare earth concentrate; wherein the method comprises the use of a waste solution treatment plant that receives solutions from the washing steps of depleted material and spent solution in the different steps of separation, sorting and washing of material and that generates the first, second, third and fourth recirculation flows.

### FIELD OF THE INVENTION

The present invention relates to the extraction and processing of minerals from the lanthanide group. In particular, the present invention relates to an improved process for the extraction, purification and production of minerals from the lanthanide group, the objective of which is to ensure the chemical stability of waste, avoid the disposal of liquid waste, and improve efficiency in terms of mineral recovery, the use of water and the use of resources used in the process, thus achieving a more environmentally friendly process.

### BACKGROUND

The so-called rare earths, which include elements from the lanthanide group, constitute strategic elements for the world of electromobility, clean energy and permanent magnets, and their different elements can be used in applications as diverse as catalysts for vehicles, wind generators or electronic equipment. However, extracting these elements is relatively complex; in fact, the name “rare” earths is because finding them in a pure form is very uncommon. In particular, in nature, these elements are usually mixed with other materials, meaning that it is difficult to extract them individually. For this reason, the extraction and processing of these minerals requires the use of different chemical products that can act as a source of pollution, generating acid or even radioactive materials.

To address these shortcomings, the applicants previously developed a system and a method for the processing of minerals from the lanthanide group and for the production of rare earth oxides, which was embodied in international patent application PCT/IB2017/051339, published under number WO 2018/162951 A1. This system and method sought to provide a closed and continuous treatment of the different materials and ion exchange agents involved in the process, in contrast to the technologies known up until then where the processing was carried out through the use of chemical products in an “open” environment, entailing a potential environmental risk in the area close to the mine. As such, the use of a closed and continuous treatment of the different materials and ion exchange agents made it possible to improve efficiency in the extraction in relation to the technologies known up until then, also allowing environmental risks to be avoided.

Nevertheless, although the original patent sought to be environmentally efficient, the inventors found in practice that the originally developed system and method did not allow high efficiency in mineral recovery. Among other operational factors, the original system was based on the use of reactors in the leaching step that were used in combination with dewatering equipment; however, it was found that, due to the granulometry of the clays present in the solutions of interest, the use of reactors required energy-intensive engines (see FIG. 1), which exhibited high wear of the mechanical elements of these units of equipment. Furthermore, the dewatering equipment exhibited operational problems with the fine material, which made the solid-liquid separation of the clay present therein very difficult. Likewise, although the original system envisaged a dewatering and washing step wherein the depleted mineral is washed and liquid with rare earth content is recovered, the processing described herein for the process solutions and the use of water shows flaws in terms of efficiency in the use of these resources.

Since the process described in document WO 2018/162951 A1 operates in a closed loop, an increase in the concentration of dissolved salts, mainly sulphates, calcium, magnesium, manganese, sodium, inter alia, occurs, where the concentration of total dissolved solids (TDS) reaches values higher than 3% or even 4%, comparable to seawater. The direct use of reverse osmosis, proposed in said document, then becomes unfeasible and causes the depleted material to be disposed of not to be chemically stable; therefore, a complex purification system is required to recover water that makes the closed circuit viable and ensures chemical stability, which is the main reason for this new invention.

Consequently, it was identified that the aforementioned shortcomings of the original system make the processing of rare earths technically and economically unfeasible under current conditions.

In view of the aforementioned problems, it can be seen that there is a need to provide a system for the extraction, purification and production of minerals from the lanthanide group, which makes it possible to ensure the chemical stability of the depleted material and improve efficiency in terms of mineral recovery, water recirculation and the use of the resources used in the process.

### SUMMARY OF THE INVENTION

To address the problems raised, a system and a method for the processing of minerals from the lanthanide group are disclosed, which makes it possible to improve efficiency in terms of mineral recovery, water recovery and the use of the resources involved in the process.

In particular, the method of the present invention is based on carrying out the following steps:
a) reception and conditioning of the raw material, wherein a material of interest is obtained, which is mixed with a first recirculation flow to generate a first material flow of interest;
b) sorting of the material flow of interest, wherein the incoming material is mixed with a second recirculation flow and sorted into a fine material line and a coarse material line;
c) extraction of lanthanides, wherein the material from the fine material line makes contact with a third recirculation flow and with a flow of ion exchange promoter solution, thus obtaining a flow of loaded material;
d) precipitation of impurities, wherein the flow of loaded material makes contact with a fourth recirculation flow and with a solution of ammonium bicarbonate, ammonium hydroxide, anhydrous ammonia or sodium hydroxide in order to remove impurities by precipitation;
e) precipitation of rare earth concentrate, wherein the incoming flow makes contact with a solution of ammonium bicarbonate, ammonium hydroxide, anhydrous ammonia or sodium hydroxide; and
f) drying of the rare earth concentrate;
wherein the method comprises the use of a waste solution treatment plant that receives solutions from the washing steps of depleted material and spent solution in the different steps of separation, sorting and washing of material and that generates the first, second, third and fourth recirculation flows; and
wherein the first, second, third and fourth recirculation flows comprise different solutions that are sorted into two types, a flow of “clean water”, comprising a solution with a negligible concentration of ammonium and sulphate, which is used for washing spent material, and a flow of recirculated solution comprising a high concentration of ammonium sulphate.
As such, the method of the present invention envisages the use of a waste solution treatment plant, which allows the solutions recovered from different parts of the process to be reused for waste washing, the preparation of reagents, or they are recirculated through the different recirculation flows. More particularly, the different solutions that are fed into the treatment plant come from processes of solid/liquid separation, material washing in the sorting steps of the material flow of interest, the extraction of lanthanides and precipitation of lanthanide concentrate. Thus, this configuration makes it possible to ensure the chemical stability of the depleted material, and the recovery of process water and reagents, thus improving the extraction of the product from the material and decreasing the necessary supply of water in the processing plant, the use of reagents and avoiding the release of liquid industrial waste into the environment.

Consequently, the described method has made it possible to make the process of generating rare earth concentrates more efficient while favouring the washing of clays, thus allowing the relevant content of the earth to be recovered by using solution recirculation processes in the different steps of the process and ensuring the chemical stability of the depleted material. Furthermore, in order to make the processes for treating clay and, in general, depleted material more efficient, the present invention avoids the use of reactors in combination with dewaterers, by using thickeners in the leaching step in combination with filtration means in the different steps of material processing.

On the other hand, the present invention further includes a system for carrying out the steps of the method described above, which comprises:
raw material reception and conditioning means, wherein a material of interest is obtained which is mixed with a first recirculation flow to generate a first material flow of interest;
material flow of interest sorting means, wherein the incoming material is mixed with a second recirculation flow and sorted into a fine material line and a coarse material line;
lanthanide extraction means, wherein the material from the coarse material line makes contact with a flow of ion exchange promoter solution and with a third recirculation flow, thus obtaining a flow of loaded material;
impurity precipitation means, wherein the flow of loaded material makes contact with a fourth recirculation flow and with a solution of ammonium bicarbonate, ammonium hydroxide, anhydrous ammonia or sodium hydroxide in order to remove impurities by precipitation;
rare earth concentrate precipitation means, wherein the incoming flow is put in contact with a solution of ammonium bicarbonate, ammonium hydroxide, anhydrous ammonia or sodium hydroxide;
rare earth concentrate drying means; and
a waste solution treatment plant that receives solutions from the washing steps of depleted material and spent solution in the different steps of separation, sorting and washing of material and that generates the first, second, third and fourth recirculation flows;
wherein the first, second, third and fourth recirculation flows comprise different solutions that are sorted into two types, a flow of “clean water”, comprising a solution with a negligible concentration of ammonium and sulphate, which is used for washing spent material, and a flow of recirculated solution comprising a high concentration of ammonium sulphate.

### DESCRIPTION OF THE FIGURES

FIG. 1 shows a graph depicting the relationship between the particle size of the clays and the power in the engines of the reactor area in the system of document WO 2018/162951 A1.

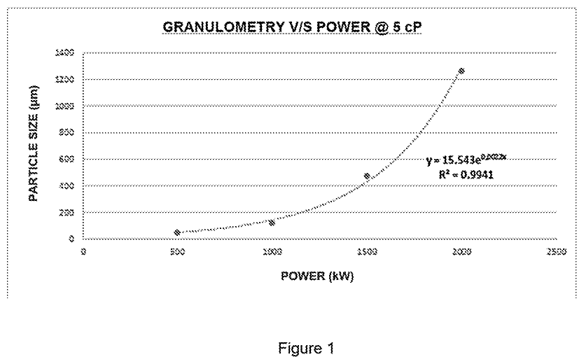

FIG. 2 shows a flow chart according to a preferred configuration of the present invention.

FIG. 3 shows a flow chart that describes in greater detail each of the steps according to the configuration of FIG. 2.

### DETAILED DESCRIPTION OF THE INVENTION

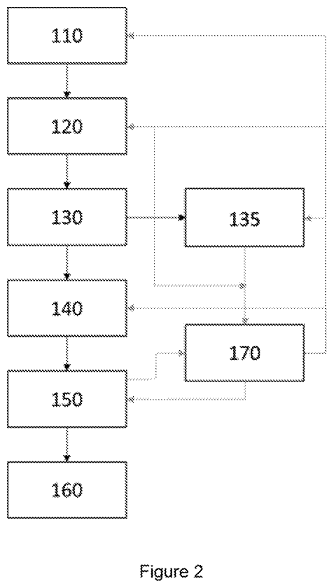

As shown in FIG. 2, the present invention relates to a method for the processing of minerals from the lanthanide group, which allows efficiency to be improved in terms of recovering the mineral and the resources involved in the process. The method comprises the steps of:
a) reception and conditioning of the raw material (110), wherein a material of interest is obtained, which is mixed with a first recirculation flow to generate a first material flow of interest;
b) sorting of the material flow of interest (120), wherein the incoming material is mixed with a second recirculation flow and sorted into a fine material line and a coarse material line;
c) extraction of lanthanides (130), wherein the fine material line is put in contact with an ion exchange promoter solution and with a third recirculation flow, obtaining a flow of loaded material;
d) precipitation of impurities (140), wherein the flow of loaded material makes contact with a fourth recirculation flow and with a solution of ammonium bicarbonate, ammonium hydroxide, anhydrous ammonia or sodium hydroxide in order to remove impurities by precipitation;
e) precipitation of rare earth concentrate (150), wherein the incoming material makes contact with a solution of ammonium bicarbonate or anhydrous ammonia, ammonium hydroxide or sodium hydroxide; and
f) drying of the rare earth concentrate (160);
wherein the method comprises the use of a waste solution treatment plant (170) that receives solutions from the washing steps of depleted material and spent solution in the different steps of separation, sorting and washing of material and that generates the first, second, third and fourth recirculation flows; and
wherein the first, second, third and fourth recirculation flows comprise different solutions that are sorted into two types, a flow of “clean water”, comprising a solution with a negligible concentration of ammonium and sulphate, which is used for washing spent material, and a flow of recirculated solution comprising a high concentration of ammonium sulphate.

As shown in FIG. 2, in the lanthanide extraction step (130) two streams are obtained, a flow of lanthanide-laden material that is sent to the impurity precipitation step (140), and a pulp with spent material that is preferably sent to a solid/liquid separation step (135), which purpose is to recover the remaining lanthanides contained in said pulp. In this step, the pulp with spent material is fed to separation means, preferably filter presses, wherein a spent material solid is obtained and a laden solution is obtained that is sent to the waste solution treatment plant (170), so that it is subsequently reused in the process. Furthermore, in this configuration, the obtained solid, corresponding to depleted material, goes through a washing process with clean water from the water recovery plant in order to ensure the chemical stability of the waste, and to be transported to the final disposal. The solution obtained by washing the solid obtained, like other washing solutions from other steps of the process, is also sent to the waste solution treatment plant (170), in order to be purified and subsequently reused in the process.

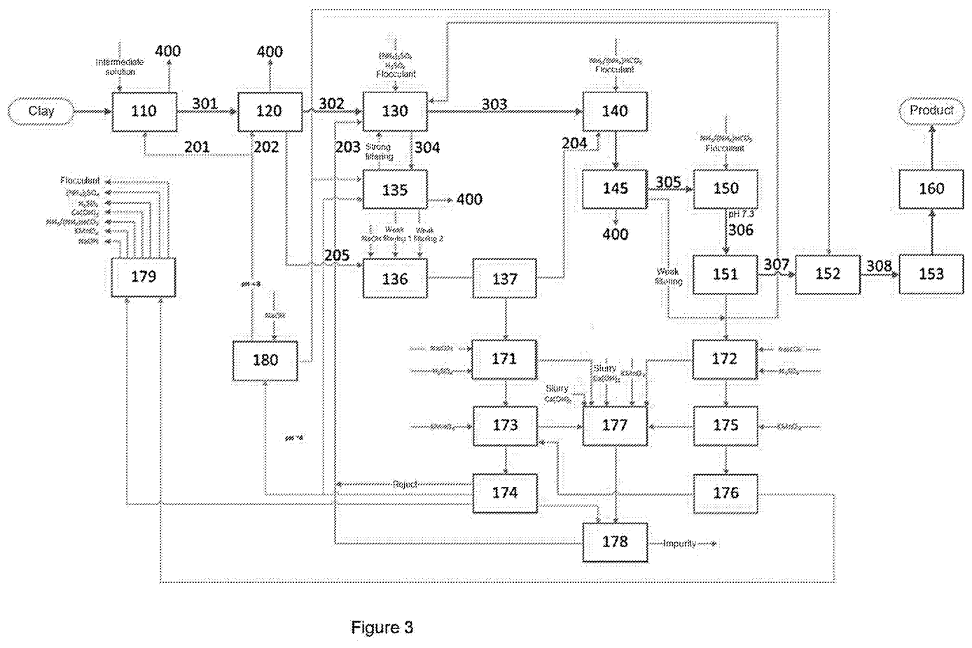

FIG. 3 shows a preferred configuration of the invention in greater detail, wherein each of the particularities of the steps of the method is shown.

According to FIG. 3, the reception and conditioning of the raw material step (110) comprises the reception of the material from the extraction area, preferably in feed hoppers with filtration means that prevent stones, plants or other unwanted objects from entering. The material is preferably discharged to a scrubber cylinder wherein the material is put in contact with the first recirculation flow (201), which comprises in this case a flow of clean water from the waste solution treatment plant (170). The scrubber cylinder is preferably connected to a trommel, wherein the coarse particles are separated to be transferred to the final disposal (400) in a waste tank (not shown in the figures). The remaining particles, mixed with the first recirculation flow (201), produce the first material flow of interest (301), which is sent to the material flow of interest sorting step (120).

In the material flow of interest sorting step (120), the first material flow of interest (301) is subjected to filtration means, preferably by wet sorting, wherein all the material particles greater than a threshold diameter, preferably 1 mm, are separated, thus generating the fine material and coarse material lines. The coarse material line, which comprises particles of a size larger than said threshold, are separated and subsequently washed, to then be sent to the final disposal (400) in said waste tank. The remaining particles, which have a size smaller the threshold value, are mixed in a container enabled for this purpose with a second recirculation flow (202), thus obtaining the second material flow of interest (302), which is sent to the lanthanide extraction step (130).

In the lanthanide extraction step (130), the second material flow of interest (302) undergoes a lanthanide extraction process, preferably by cation exchange. In this step, the second material flow of interest (302) is processed in thickeners, wherein it is put in contact with a solution for ionic exchange, preferably comprising ammonium sulphate for the extraction of the lanthanides present in the solution. The external solid/liquid ratio of this step is preferably in a range between 1:1, 1:2 and 1:3 and with a residence time between 1 and 4 hours. Furthermore, in preferred configurations of the invention, a solution of dilute sulphuric acid is added in this step, in order to control the pH, preferably between 2 and 4, a flocculant solution to improve the thickening process, and the flow is also put in contact with the third recirculation flow (203), which in this case corresponds to a flow of recirculated solution, in order to efficiently use water. From this step, a flow of loaded material (303) is thus obtained, which is sent to the impurity precipitation step (140).

From the lanthanide extraction step (130), a flow of pulp with spent material (304) is also obtained, which is sent to a solid/liquid separation step (135) which purpose is to recover the remaining lanthanides contained in the solution and impregnated with the solid. The solid/liquid separation step (135) preferably comprises the use of filter presses, where a spent material solid (400) is obtained with an approximate moisture content between 20% and 25% and a lanthanide-containing solution which is sent to a precipitation step (136). In the filter presses of the solid/liquid separation step (135), the spent material solid (400) goes through a washing step with a flow of clean water where the chemical stability of the waste is ensured, and it is sent to the final disposal in the waste tank. The solution obtained by washing the spent material solid is purified in the treatment plant of the waste solution treatment plant (170), in order to be reused in the process. In the precipitation step (136), a lanthanide-containing solution is received, to which a lanthanide precipitation reagent is added, such as sodium hydroxide, and preferably a flow of recirculated solution (205) from the washing of the coarse material line in the sorting step (120) is also added. From the precipitation step (136), a flow is obtained that is sent to a filtering step (137), wherein the lanthanide-containing precipitates are separated from a flow of solution. In this configuration, the lanthanide-containing precipitates are obtained in the form of pulp, which corresponds to the fourth recirculation flow (204), which is sent to the impurity precipitation step (140), while the remaining solution from the filtering step (136) is sent to the waste solution treatment plant (170).

In other configurations of the invention, the possibility is envisaged that the third recirculation flow (203) and fourth recirculation flow (204) are mixed in a container medium (not shown in the figures), from which it is distributed to the lanthanide extraction step (130) and impurity precipitation step (140).

In the impurity precipitation step (140), the flow of lanthanide-laden material is fed to one or more reactors, preferably stirred reactors, wherein it makes contact with a solution of ammonium bicarbonate, ammonium hydroxide, anhydrous ammonia or sodium hydroxide, in order to adjust the pH of the solution, preferably in a range between 4.5 and 6, and with a residence time between 20 and 60 minutes, which allows impurities such as aluminium and iron to be removed by precipitation. Furthermore, in this step the flow of loaded material is put in contact with the fourth recirculation flow (204). In some configurations of the invention, a flocculant is also added in this step, in order to improve the solid/liquid separation process.

The material obtained in this step, with the precipitated impurities, is subjected to a filtration process (145). Preferably, the spent solid (400) that is obtained in this filtration process is washed with clean water, and the already washed solid is sent to the final disposal (400) in the waste tank. In preferred configurations of the invention, the solution obtained from washing the spent material is recirculated in the process.

On the other hand, the impurity-free solution that is obtained after the filtration process (145) is sent in the form of a flow of impurity-free solution (305) to the rare earth concentrate precipitation step (150). In this step, the impurity-free, lanthanide-laden solution is fed to one or more reactors, preferably stirred reactors, wherein it is put in contact with a solution of ammonium bicarbonate, anhydrous ammonia, ammonium hydroxide or sodium hydroxide, which allows the solution to reach a pH in the range between 6 and 7.5, with a residence time that is preferably between 20 and 60 minutes, which facilitates lanthanide precipitation. In some configurations of the invention, a flocculant solution can be added in this step in order to optimise the rare earth concentrate precipitation process.

A product of the generated reactions, a precipitated lanthanides-laden flow (306) is obtained from the reactors, which is sent to a new solid/liquid separation step (151), which preferably comprises the use of filter presses. In some configurations of the invention, this solid/liquid separation step (151) includes the use of two or more filters connected in series, to optimise the recovery process. From the filtration process, a flow of lanthanide-laden pulp (307), which is sent to a washing step (152) and subsequent filtering step (153), and a liquid solution of spent material, containing a high content of dissolved solids, and which is sent to the waste solution treatment plant (170), is obtained, for subsequent reuse in the process. In the washing step (152), the flow of lanthanide-laden pulp (307) is washed with clean water and then filtered (153), from where a new washing solution is obtained that is also sent to the waste solution treatment plant (170), for subsequent reuse in the process. Furthermore, in this washing step (152), a pulp (308) is obtained that is sent to a filtering step (153) and subsequently to the rare earth concentrate drying step (160), from where a dry product is obtained that is sent to a cooler to then be packaged.

In addition, the present invention also envisages a system for the processing of rare earth concentrate, which carries out the method described above, and which comprises the following elements:
raw material reception and conditioning means, wherein a material of interest is obtained which is mixed with a first recirculation flow (201) to generate a first material flow of interest (301);
material flow of interest sorting means, wherein the incoming material is mixed with a second recirculation flow and sorted into a fine material line (302) and a coarse material line;
lanthanide extraction means, wherein the fine material line (302) is put in contact with a flow of an ion exchange promoter solution and with a third recirculation flow (203), and wherein a flow of loaded material (303) is obtained;
impurity precipitation means, wherein the flow of loaded material makes contact with a fourth recirculation flow (204) and with a solution of ammonium bicarbonate or anhydrous ammonia, ammonium hydroxide or sodium hydroxide in order to remove impurities by precipitation;
rare earth concentrate precipitation means, wherein the incoming material is put in contact with a solution of ammonium bicarbonate or anhydrous ammonia, ammonium hydroxide or sodium hydroxide;
rare earth concentrate drying means; and
a waste solution treatment plant (170) that receives solutions from the washing steps of depleted material and spent solution in the different steps of separation, sorting and washing of material and that generates the first, second, third and fourth recirculation flows;
wherein the first, second, third and fourth recirculation flows comprise different solutions that are sorted into two types, a flow of “clean water”, comprising a solution with a negligible concentration of ammonium and sulphate, which is used for washing spent material, and a flow of recirculated solution comprising a high concentration of ammonium sulphate.

Preferably, the raw material reception and conditioning means include means for transporting the material, which supply the raw material to the feed hoppers that include means to prevent stones, branches or other unwanted objects from entering.

On the other hand, the material flow of interest sorting means comprise the use of wet sorting means that separate all the material particles larger than a threshold diameter, preferably 1 mm. Preferably, said sorting means include the use of screens or other similar devices.

The lanthanide extraction means comprise the use of one or more units of thickening equipment, wherein optionally the material of interest can be extracted from the clay in different steps connected in series and in countercurrent with an ion exchange promoter solution, which preferably comprises a solution of ammonium sulphate. Furthermore, in the lanthanide extraction step, as well as in other steps of the process, solid/liquid separation means are used, which preferably include the use of filter presses.

In particular, it should be taken into account that the combination of thickeners together with the separation of material through filter presses makes it possible to achieve better performance in the treatment of the mineral and in the separation of clays, compared with the use of reactors and dewatering tables that were used in the original patent application of the same applicant (international publication number WO 2018/162951 A1). This constitutes one of the most important advantages of the present invention in relation to said previous technology.

The impurity precipitation means preferably comprise impurity reactors, which receive a solution of ammonium bicarbonate or anhydrous ammonia, ammonium hydroxide or sodium hydroxide in order to remove impurities by precipitation, in addition to receiving a fourth recirculation flow and, optionally, a flocculant solution to facilitate precipitation.

The rare earth concentrate precipitation means preferably comprise the use of one or more stirred reactors, wherein a solution of ammonium bicarbonate or anhydrous ammonia, ammonium hydroxide or sodium hydroxide is added to allow lanthanides to precipitate. Subsequently, the resulting flow is sent to one or more containers wherein a flocculant solution is added.

The drying means preferably comprise drying equipment, which optionally considers the use of electrically heated oil to thus avoid using fossil fuels and to be more environmentally friendly. Furthermore, gases are generated in the drying process that may contain ammonia, such that said gases are preferably treated in a gas washing system to be subsequently released into the environment. The dry product obtained by the drying means is sent to cooling means, which lower the temperature of the solid to then be discharged to a material handling system that will take the material to a packaging step.

The purpose of the waste solution treatment plant (170) is to receive solutions from the processing of material in the different steps of the process, to allow them to be reused through recirculation flows, thus avoiding the release of liquid industrial waste (LIW), making it possible to have chemically stable waste, reduce the use of reagents and decrease the use of fresh water. For this purpose, the waste solution treatment plant (170) considers means for the removal of divalent cations, such as calcium, magnesium or manganese.

Preferably, the waste solution treatment plant (170) comprises two types of treatment, since the lanthanide concentrate production process generates two qualities of solution that is to be recovered. More particularly, the waste solution treatment plant (170) comprises a low total dissolved solids (TDS) solution treatment line (171, 173 and 174) and a high TDS solution treatment line (172, 175 and 176).

The low TDS solution treatment line allows the processing of solutions with a smaller amount of dissolved solids, which comes mainly from the washing of depleted material. The solution obtained from said washing steps is subjected to a softening step in a first softening plant (171), subsequently it continues towards a manganese oxidation step (173) and then it is sent to a reverse osmosis plant (174). After this step, both the permeate, which is used mainly for washing waste, and the reject are reused in the different steps of the process. The permeate obtained generates a flow of clean water that is used in the different steps of the lanthanide extraction process, and the quality of this permeate or clean water obtained is similar to that of commercial demineralised water.

The high TDS solution treatment line allows the processing of solutions with a higher content of dissolved solids, which comes from the rare earth concentrate precipitation step (150). Like the low TDS solution, this flow enters a second softening plant (172), then a manganese oxidation step (175) and subsequently, due to the high TDS, which is mostly a useful reagent for extraction, this solution is treated in a nanofiltration process (176) (preferably with semi-permeable membranes of between 0.001 and 0.01 mm), where the permeate obtained is sent to the filtration step by reverse osmosis (174) mentioned above. The reject is directed to the water distribution area to be reused in the process where necessary.

More particularly, for the treatment of the solution coming from the rare earth concentrate precipitation (150), the use of ion exchange columns is considered for the removal of divalent cations, such as calcium, magnesium or manganese. Then, in the manganese oxidation step (175), its abatement is carried out as manganese oxide through the reaction with potassium permanganate or greensand filters, and the magnesium oxide is removed with polishing filters and mixed with the depleted clay to be sent to the final disposal. Furthermore, the discard obtained in the nanofiltration process (176) is recirculated as an ion exchange agent to the lanthanide extraction step (130), while the permeate is treated jointly with the solutions that come from the different washing steps of depleted material (400), feeding ion exchange and manganese oxidation columns, generating a low TDS solution like in the previously described step. This solution has about 1% TDS meaning that it can feed the reverse osmosis unit, from where the flow of clean water is generated to wash and condition the clay or depleted material (400), while the reject of this process is used for a reagent preparation step of the process (179).

In preferred configurations of the invention, the waste solution treatment plant (170) further comprises an oxidation and neutralisation system (177), which processes the purges obtained from the softening steps (173, 175), both in the low TDS and high TDS solutions. More particularly, in this step the solutions collected in the softening steps are removed through a process of oxidation and adjustment to basic pH, preferably through the addition of potassium permanganate and lime slurry, mainly generating calcium sulphate dihydrate (gypsum). The pulp obtained from impurities, product of the neutralisation, continues towards a solid/liquid separation process (178), obtaining a solid waste that will be sent to the final disposal in the waste tank. On the other hand, the neutralised and filtered solution is reused in the process.

Lastly, the waste solution treatment plant (170) preferably includes a pH adjustment step (180) wherein a flow from the reverse osmosis filtration step (174) is received, and wherein sodium hydroxide is added in order to adjust the pH of the incoming solution, to then be sent as recirculation flows to different steps of the process. The pH adjustment step (180) allows the clay washing water to be conditioned in such a way that the washed depleted clay allows the revegetation of an ecosystem which allows the growth of preservation species, such as Gomortega keule, Pitavia punctata and Citronella mucronata.

The foregoing description relates to the configuration of the figures, which refers to one of the preferred embodiments of the invention; however, it is important to consider that different aspects of said description may vary. For example, the number of units of equipment used, the type of equipment selected, the dimensions, the choice of materials, and specific aspects of the preferred configurations described above may vary or be modified based on the operational requirements. Accordingly, the description of the specific configurations described above is not intended to be limiting, and possible variations and/or modifications thereof are within the spirit and scope of the invention.

1. A method for the processing of minerals from the lanthanide group, which allows efficiency to be improved in terms of recovering the mineral and the resources involved in the process, CHARACTERISED in that it comprises the steps of:
a) reception and conditioning of the raw material (110), wherein a material of interest is obtained, which is mixed with a first recirculation flow to generate a first material flow of interest;
b) sorting of the material flow of interest (120), wherein the incoming material is mixed with a second recirculation flow and sorted into a fine material line and a coarse material line;
c) extraction of lanthanides (130), wherein the fine material line is put in contact with an ion exchange promoter solution and with a third recirculation flow, obtaining a flow of loaded material;
d) precipitation of impurities (140), wherein the flow of loaded material makes contact with a fourth recirculation flow and with a solution of ammonium bicarbonate, ammonium hydroxide, anhydrous ammonia or sodium hydroxide in order to remove impurities by precipitation;
e) precipitation of rare earth concentrate (150), wherein the incoming material makes contact with a solution of ammonium bicarbonate or anhydrous ammonia, ammonium hydroxide or sodium hydroxide; and
f) drying of the rare earth concentrate (160);
wherein the method comprises the use of a waste solution treatment plant (170) that receives solutions from the washing steps of depleted material and spent solution in the different steps of separation, sorting and washing of material and that generates the first, second, third and fourth recirculation flows;
wherein the first, second, third and fourth recirculation flows comprise different solutions that are sorted into two types, a flow of “clean water”, comprising a solution with a negligible concentration of ammonium and sulphate, which is used for washing spent material, and a flow of recirculated solution comprising a high concentration of ammonium sulphate.

2. The method according to claim 1, CHARACTERISED in that the first, second, third and fourth recirculation flows comprise different solutions that are sorted into two types, a flow of “clean water”, comprising a solution with a negligible concentration of ammonium and sulphate, and which is used for washing spent material, and a flow of recirculated solution comprising a high concentration of ammonium sulphate.

3. The method according to claim 2, CHARACTERISED in that in the reception and conditioning of the raw material step (110), the first recirculation flow (201) comprises a flow of clean water, wherein the raw material enters a scrubber cylinder connected to a trommel, wherein the coarse particles are separated to be transferred to a waste tank and the remaining particles, mixed with the first recirculation flow (201), produce the first material flow of interest (301).

4. The method according to claim 2, CHARACTERISED in that in the material flow of interest sorting step (120), the first material flow of interest (301) is separated according to a threshold diameter, generating fine material and coarse material lines, wherein the particles of the coarse material line are separated and washed before being sent to a waste tank, and the fine material line is mixed with the second recirculation flow (202) to obtain the second material flow of interest (302).

5. The method according to claim 4, CHARACTERISED in that the second recirculation flow (202) comprises two flows, a flow of clean water that is used to wash the particles from the coarse material line, and a flow of recirculated solution that is mixed with the fine material line.

6. The method according to claim 2, CHARACTERISED in that in the lanthanide extraction step (130), the second material flow of interest (302) is processed in thickeners, wherein it is put in contact with a solution for ion exchange comprising ammonium sulphate, a solution of dilute sulphuric acid to control the pH, a flocculant solution to improve the thickening process and with the third recirculation flow (203) which corresponds to a flow of recirculated solution.

7. The method according to claim 6, CHARACTERISED in that the external solid/liquid ratio is in a range between 1:1, 1:2 and 1:3, with a residence time between 1 and 4 hours, and the pH is controlled between 2 and 4.

8. The method according to claim 6, CHARACTERISED in that from the lanthanide extraction step (130), a flow of pulp with spent material (304) is obtained, which is sent to a solid/liquid separation step (135) wherein the remaining lanthanides contained in said pulp are recovered, in which a spent material solid (400) and a lanthanide-containing solution are obtained, and wherein the spent material solid (400) goes through a washing step with a flow of clean water before being sent to the waste tank.

9. The method according to claim 1, CHARACTERISED in that in the impurity precipitation step (140), the flow of lanthanide-laden material is processed in one or more stirred reactors, wherein the pH of the solution is adjusted in a range between 4.5 and 6, and with a residence time between 20 and 60 minutes, which allows impurities to be

10. The method according to claim 9, CHARACTERISED in that the material obtained, with the precipitated impurities, is subjected to a filtration process (145), wherein a spent solid (400) is obtained, which is washed with a flow of clean water before being sent to the waste tank and the solution obtained from washing the spent material is recirculated in the process.

11. The method according to claim 1, CHARACTERISED in that in the rare earth concentrate precipitation step (150), the incoming solution is processed in one or more stirred reactors, wherein it is put in contact with a solution of ammonium bicarbonate, anhydrous ammonia, ammonium hydroxide or sodium hydroxide, which allows the solution to reach a pH in the range between 6 and 7.5, with a residence time that is preferably between 20 and 60 minutes, which facilitates lanthanide precipitation.

12. The method according to claim 11, CHARACTERISED in that a precipitated lanthanides-laden flow (306) is obtained from the reactors, which is sent to a new solid/liquid separation step (151), wherein a flow of lanthanide-laden pulp (307) is obtained, which is sent to a washing step (152) and subsequent filtering step (153), and a liquid solution of spent material that is sent to the waste solution treatment plant (170).

13. A system for the processing of rare earth concentrate, CHARACTERISED in that it comprises:
raw material reception and conditioning means, wherein a material of interest is obtained which is mixed with a first recirculation flow (201) to generate a first material flow of interest (301);
material flow of interest sorting means, wherein the incoming material is mixed with a second recirculation flow and sorted into a fine material line (302) and a coarse material line;
lanthanide extraction means, wherein the fine material line (302) is put in contact with a flow of an ion exchange promoter solution and with a third recirculation flow (203), and wherein a flow of loaded material (303) is obtained;
impurity precipitation means, wherein the flow of loaded material makes contact with a fourth recirculation flow (204) and with a solution of ammonium bicarbonate or anhydrous ammonia, ammonium hydroxide or sodium hydroxide in order to remove impurities by precipitation;
rare earth concentrate precipitation means, wherein the incoming material is put in contact with a solution of ammonium bicarbonate or anhydrous ammonia, ammonium hydroxide or sodium hydroxide;
rare earth concentrate drying means; and
a waste solution treatment plant (170) that receives solutions from the washing steps of depleted material and spent solution in the different steps of separation, sorting and washing of material and that generates the first, second, third and fourth recirculation flows;
wherein the first, second, third and fourth recirculation flows comprise different solutions that are sorted into two types, a flow of “clean water”, comprising a solution with a negligible concentration of ammonium and sulphate, which is used for washing spent material, and a flow of recirculated solution comprising a high concentration of ammonium sulphate.

14. The system according to claim 13, CHARACTERISED in that the waste solution treatment plant (170) comprises a low total dissolved solids (TDS) solution treatment line and a high total dissolved solids (TDS) solution treatment line.

15. The system according to claim 14, CHARACTERISED in that the low TDS solution treatment line processes solutions that come from washing depleted material, wherein the incoming flow is subjected to a softening step in a first softening plant (171), a manganese oxidation step (173) and then it is sent to a reverse osmosis plant (174), wherein the permeate obtained generates a flow of clean water that is used in different steps of the process.

16. The system according to claim 15, CHARACTERISED in that the high TDS solution treatment line processes solutions that come from the rare earth concentrate precipitation means, wherein the flow enters a second softening plant (172), then a manganese oxidation step (175) and subsequently it is treated in a nanofiltration process (176), wherein the permeate obtained is sent to the filtration step by reverse osmosis (174).

17. The system according to claim 16, CHARACTERISED in that the high TDS solution treatment line comprises the use of ion exchange columns for the removal of divalent cations, such as calcium, magnesium or manganese, and in the manganese oxidation step (175) its abatement is carried out as manganese oxide through the reaction with potassium permanganate or greensand filters, wherein the magnesium oxide is removed and mixed with depleted material to be sent to a waste tank.

18. The system according to claim 16, CHARACTERISED in that the discard obtained in the nanofiltration process (176) is recirculated as an ion exchange agent to the lanthanide extraction means, and the permeate is treated jointly with the solutions that come from the different washing steps of depleted material (400).

19. The system according to claim 16, CHARACTERISED in that the waste solution treatment plant (170) further comprises an oxidation and neutralisation system (177) that processes the purges obtained from the softening steps (173, 175) of the low TDS and high TDS solutions, wherein the solutions are subjected to a process of oxidation and adjustment to basic pH, by adding potassium permanganate and lime slurry, mainly generating calcium sulphate dihydrate, and wherein the solution obtained is reused in the process.
